(19) United States
(12) Patent Application Publication
(10) Pub. No.: US 2008/0223301 A1
(43) Pub. Date: Sep. 18, 2008

(54) CANINE HOUSEBREAKING DEVICE

(76) Inventor: Glenn S. Nagao, Garden Grove, CA (US)

Correspondence Address: DOBRUSIN & THENNISCH PC, 29 W LAWRENCE ST, SUITE 210, PONTIAC, MI, 48342, US

(21) Appl. No.: 12/035,196

(22) Filed: Feb. 21, 2008

Related U.S. Application Data
(60) Provisional application No. 60/894,434, filed on Mar. 12, 2007.

(51) Int. Cl. A01K 29/00; B23P 17/04

(52) U.S. Cl. 119/161; 29/592

(57) ABSTRACT

The present invention is a device comprising a disposable substrate that can be folded to form at least two sections including an upstanding section and a bottom section wherein the bottom section contains adhesive means for securing the device to excrement collection means. The substrate of the device is optionally treated with an elimination attractant. The present invention also includes a method of making the above-described device.

### CLAIM OF BENEFIT OF FILING DATE

This application claims the benefit of U.S. Provisional Application Ser. No. 60/894434 titled: “Canine Housebreaking Device” filed on Mar. 12, 2007.

### FIELD OF THE INVENTION

This invention generally related to a device to assist housebreaking of canines and more specifically it relates to a device that can be placed upon excrement collection means to encourage canines to urinate in a specific desired area upon the excrement collection means.

### BACKGROUND OF THE INVENTION

Various items have been used to encourage excrement released by canines onto a specific desired area. For examples, newspapers and pee pads are traditionally used for such encouragement, especially in an indoor environment. The problem with newspapers and pee pads are that male dogs tend to urinate not only on them but in their general surrounding areas causing soiling of such areas.

### SUMMARY OF THE INVENTION

The present invention solves this problem by providing a device that can be placed in a desired location on top of the excrement collection means (e.g., newspapers, pee pads, or the like.) The device helps to direct urine from a male dog onto the excrement collection means without soiling the surrounding area so as to allow for proper and easy disposal of excrements. The device is comprised of a disposable substrate that can be folded to form at least two sections including an upstanding section and a bottom section wherein the bottom section contains adhesive means for securing the device to excrement collection means. It is preferred that the substrate is treated with an elimination attractant.

### BRIEF DESCRIPTION OF THE DRAWINGS

The features and inventive aspects of the present invention will become more apparent upon reading the following detailed description, claims, and drawings, of which the following is a brief description:

FIG. 1 is a diagrammatic prospective view of an embodiment of a device in accordance to the principles of the present invention;

FIG. 2 is a diagrammatic side view of another embodiment of a device in accordance to the principles of the present invention;

FIG. 3 is a diagrammatic prospective view of yet another embodiment of a device in accordance to the principles of the present invention;

FIG. 4 is a diagrammatic unfolded view of an embodiment of a device in accordance to the principles of the present invention;

FIGS. 5-9 are front views of various embodiments of an upstanding section of a device in accordance to the principles of the present invention;

FIG. 10 is a photograph of another embodiment of a device in accordance to the principles of the present invention;

FIG. 11 is a photograph of the device shown in FIG. 10 in a folded fashion;

FIG. 12 is a photograph of another embodiment of a device in accordance to the principles of the present invention; and

FIG. 13 is a photograph of the device shown in FIG. 12 in a folded fashion.

### DETAILED DESCRIPTION OF THE PREFERRED EMBODIMENT

The present invention provides a disposable device 100 that assists housebreaking of canines. The device 100 is designed to be placed upon excrement collection means to encourage canines to urinate in a specific desired area upon the excrement collection means.

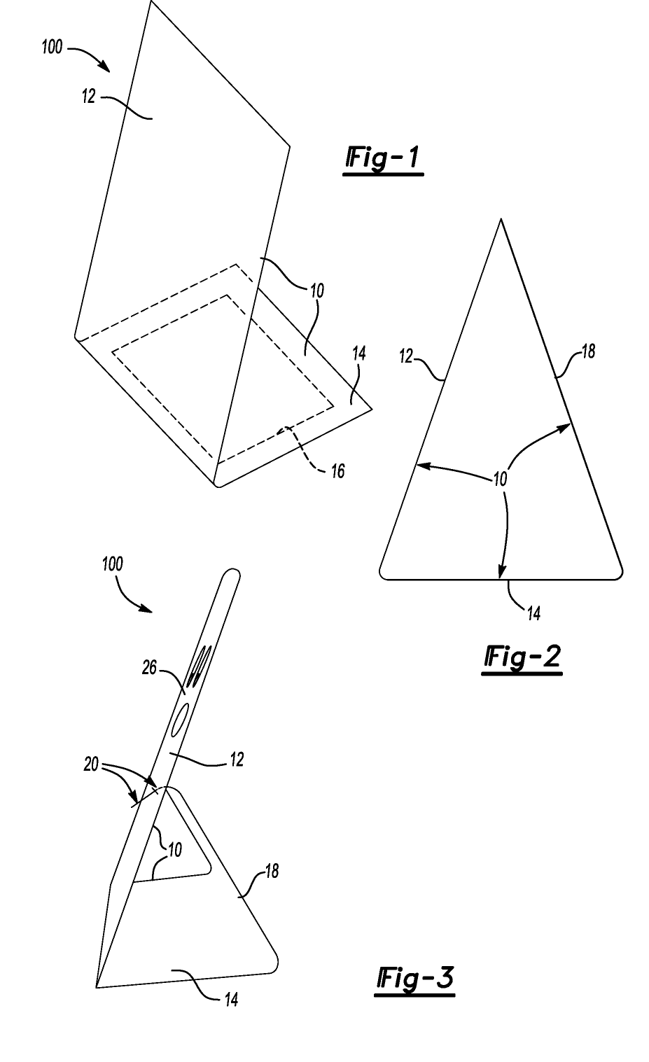

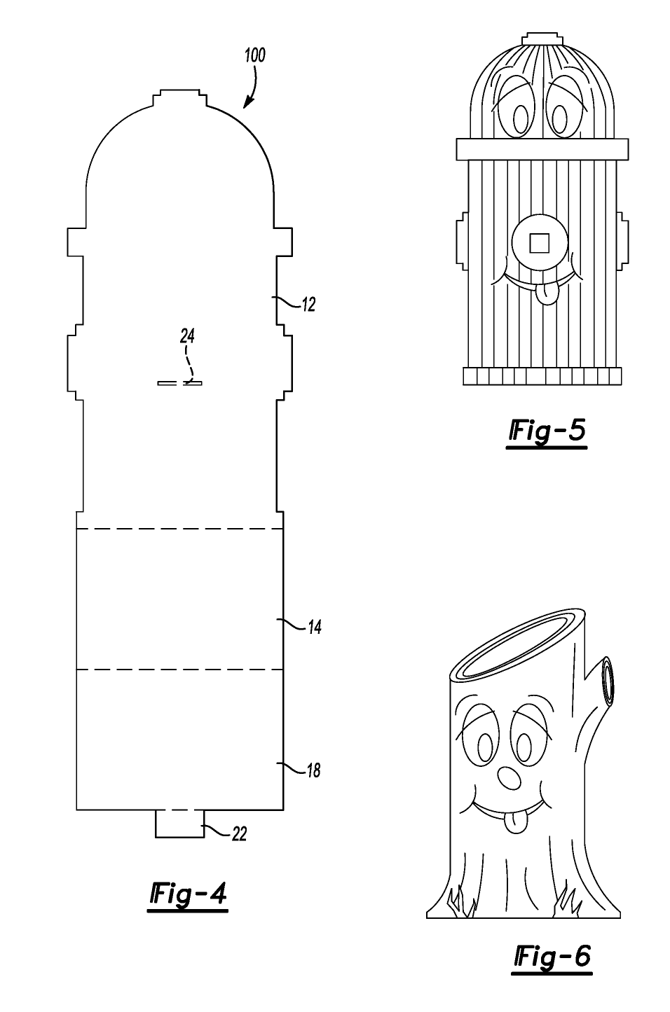

Referring to FIG. 1, the device 100 is comprised of a disposable substrate 10 that can be folded to form at least two sections including an upstanding section 12 and a bottom section 14 wherein the bottom section 14 contains adhesive means 16 for securing the device 100 to excrement collection means (not shown). The excrement collection means can be any art-disclosed means to collect canine excrement such as newspapers, plastic sheets, plastic bags, commercially available pee pads, and a combination thereof. The adhesive means 16 can be any suitable art-disclosed adhesive. Alternatively, the substrate 10 of the device 100 can optionally include a supporting section 18 as shown in FIGS. 2-3. It is preferred that the supporting section is attached to the upstanding section 12 via attachment means 20. The attachment means 20 can be any suitable art-disclosed attachment means such as adhesive, snaps, staples, a slit and tab configuration, or the like. In one embodiment of the device 100, the attachment means 20 is comprised of a slit and tab configuration whereby a tab 22 is placed into a slit 24 and thereafter the tab 22 is folded to form the attachment as shown in FIGS. 3-4.

It is preferred that the substrate 10 is treated with an elimination attractant (not shown). The elimination attractant can be any art-disclosed formulation used to aid housebreaking. See Wee-Wee Puppy Housebreaking Aid manufactured by Four Paws® located in Hauppauge, N.Y.; SIMPLE SOLUTION® Potty Training Aid for Puppies manufactured by The Bramton Company located in Dallas, Tex.; or the like.

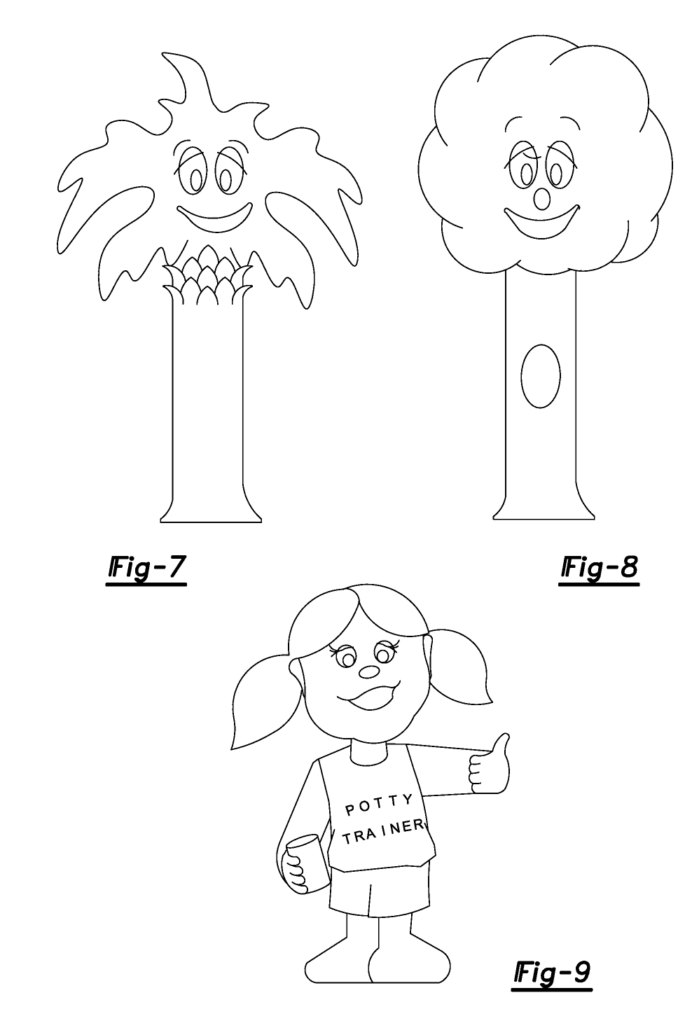

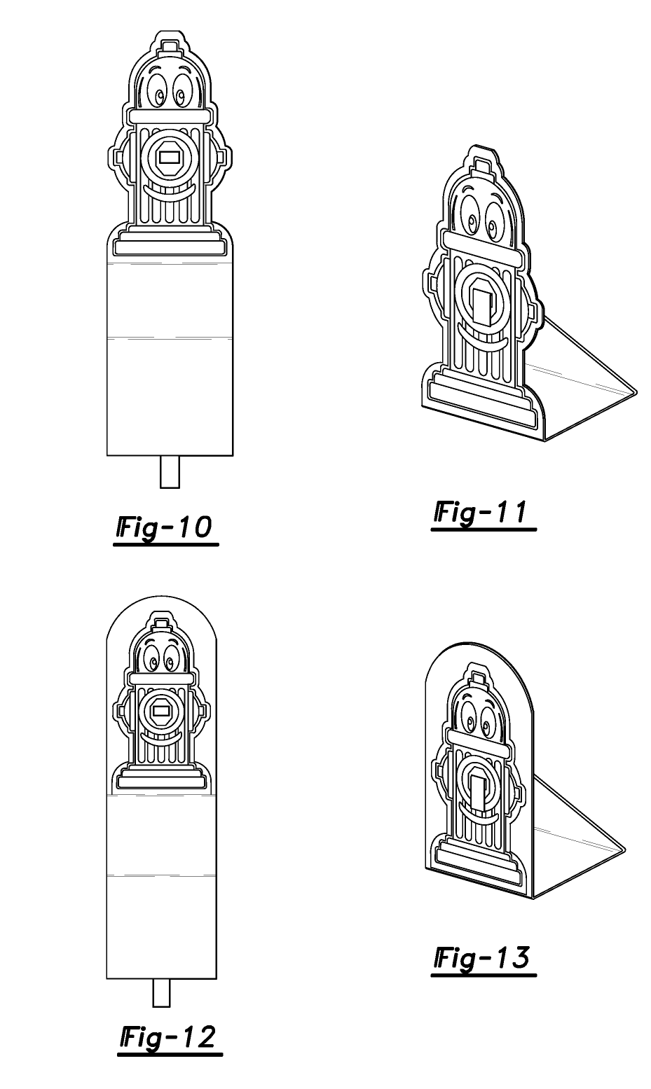

It is also preferred that at least the upstanding section 12 contains ornamental design(s) 26 as shown in FIG. 3, preferably of objects that may be attractive to canines such as trees, tree trunks, fire hydrant, individuals (i.e., persons), or the like. Examples of various ornamental designs are shown in FIGS. 5-9. Examples of various embodiments of the device 100 are also shown in FIGS. 10 and 12 in unfolded fashion and in FIGS. 11 and 13 in folded upright fashion. The device 100 when in an upright fashion can be placed upon the excrement collection means in order to encourage canines to urinate in a specific desired area upon the excrement collection means. The supporting section 18 can also optionally contain ornamental design(s).

The substrate 10 can be constructed out of any art-disclosed suitable material such as cardboards, wood, plastics, metals, metal alloys and a combination thereof. The substrate 10 can be any predetermined size and/or shape (e.g., square, rectangular, circle, diamond, triangle, irregular, etc) suitable for its purpose. The substrate 10 can be formed by a single planar material containing a fold as shown in FIG. 1 or a plurality of materials attached together at one end. The means for such attachment can be provided by any suitable art-disclosed means such as adhesive, string, stitching, snaps, staples, or a combination thereof.

The preferred embodiment of the present invention has been disclosed. A person of ordinary skill in the art would realize however, that certain modifications would come within the teachings of this invention and many other alternatives may also be employed as well in the practice of the present invention. Therefore, the following claims should be studied to determine the true scope and content of the invention.

What is claimed is:

1. A device to assist housebreaking of canines comprising a disposable substrate that can be folded to form at least two sections including an upstanding section and a bottom section wherein the bottom section contains adhesive means for securing the device to excrement collection means.

2. The device of claim 1 further comprising a supporting section that is adapted to be attached to the upstanding section via attachment means.

3. The device of claim 2 wherein the attachment means are selected from a group consisting of adhesive, snaps, staples, a slit and tab configuration, and a combination thereof.

4. The device of claim 2 wherein the supporting section includes an ornamental design.

5. The device of claim 1 wherein the upstanding section includes at least one ornamental design.

6. The device of claim 5 wherein the at least one ornamental design is attractive to canines.

7. The device of claim 5 wherein the at least one ornamental design is selected from a group consisting of tree, tree trunk, fire hydrant, person, and a combination thereof.

8. The device of claim 5 wherein the at least one ornamental design is displayed on both the upstanding section and the supporting section.

9. The device of claim 1 wherein the substrate is constructed out of material selected from a group consisting of cardboard, wood, plastic, metal, metal alloy and a combination thereof.

10. The device of claim 1 wherein the substrate has a shape selected from a group consisting of square, rectangular, circle, diamond, triangle, irregular, and a combination thereof.

11. The device of claim 1 wherein the substrate is formed by a plurality of materials attached together at one end.

12. The device of claim 1 wherein the substrate is treated with an elimination attractant.

13. The device of claim 12 wherein the elimination attractant is a commercially available liquid formulation used to aid canine housebreaking.

14. The device of claim 12 wherein the elimination attractant is selected from the group consisting Wee-Wee Puppy Housebreaking Aid manufactured by Four Paws; Simple Solution® Potty Training Aid for Puppies manufactured by The Bramton Company; and a combination thereof.

15. The device of claim 1 further comprising an excrement collection means.

16. The device of claim 15 wherein the excrement collection means is selected from a group consisting of newspaper, plastic sheet, plastic bag, commercially available pee pad, and a combination thereof.

17. A method of making a device to assist housebreaking of canines comprising:
Providing a disposable substrate that can be folded to form at least two sections including an upstanding section and a bottom section wherein the bottom section contains adhesive means for securing the device to excrement collection means.

18. The method of claim 17 wherein the substrate is treated with an elimination attractant.

19. The method of claim 17 wherein the substrate further comprising a supporting section that is adapted to be attached to the upstanding section via attachment means.

20. The method of claim 19 wherein the attachment means are selected from a group consisting of adhesive, snaps, staples, a slit and tab configuration, and a combination thereof.
